(19) United States
(12) Patent Application Publication
(10) Pub. No.: US 2024/0094417 A1
(43) Pub. Date: Mar. 21, 2024

(54) Radiation Induced Conductivity Flux Measurement Device

(71) Applicant: Surt and Hod Thermal Power Devices, Inc., Scottsdale, AZ (US)

(72) Inventors: Troy Michael HOWE, Scottsdale, AZ (US); Brianna CLEMENTS, Tucson, AZ (US)

(73) Assignee: Surt and Hod Thermal Power Devices, Inc., Scaottsdale, AZ (US)

(21) Appl. No.: 18/368,694

(22) Filed: Sep. 15, 2023

Related U.S. Application Data
(60) Provisional application No. 63/407,934, filed on Sep. 19, 2022.

(51) Int. Cl. G01T 3/08; G01T 7/00; G21C 17/108

(52) U.S. Cl. CPC G01T 3/08; G01T 7/005; G21C 17/108

(57) ABSTRACT

A detector including a resistance measuring device connected to a first conductive wire and a second conductive wire. The detector can be formed of a material that experiences Radiation Induced Conductivity (MC) when exposed to radiation and can be placed in a radiation field to measure electrical resistivity of the detector and the radiation field to gauge a strength of the radiation field. As the radiation field increases, the electrical resistivity of the detector decreases. Additionally, a combination detector can include a first detector with a first wire and a first material, and a second detector with a second wire coated with a coating comprising a fast or thermal neutron absorber. When placed in the thermal neutron field, the coating on the second detector removes a portion of thermal neutrons and leaves RIC effects on the second wire below the coating due to a remaining portion of thermal neutrons.

### CROSS REFERENCE TO RELATED APPLICATION

This application claims the benefit of the filing date of U.S. Provisional Patent Application No. 63/407,934, filed Sep. 19, 2022, the disclosure of which is incorporated, in its entirety, by this reference.

### SUMMARY

Measuring radiation levels, particularly neutron flux levels, is a difficult task which is very important for reliable operation and control of fission reactors. Current methods include fission chambers and ion chambers which interact with radiation and convert a response to electric signals. However, these units require large volumes and cannot easily take readings in-core or at multiple points in a reactor.

In one aspect, the Radiation Induced Conductivity Flux Measurement Device detailed herewithin is much smaller than a current system and uses a different method of detecting radiation effects.

Radiation Induced Conductivity (MC) is a phenomenon which takes place when ionizing radiation interacts with matter and increases the electrical conductivity of the material. This has been seen to take place in alumina, boron nitride, lithium zirconate, elemental boron, and other materials.

By using MC effects to detect radiation, a small detector can be made using electronic means. This removes the need for the large volumes used by fission chambers and ion chambers, as there is no need for cascade effects or buildup of charge.

In at least one embodiment, an exemplary embodiment is comprised of a detector between two conductive wires and a resistance measurement device on the other end of the wires. The detector is made of some material which experiences RIC when exposed to radiation. Examples may be boron, lithium zirconate, boron nitride, alumina, boron carbide, nickel oxide, or other materials. The invention operates by measuring the electrical resistivity of the detector probe while in a radiation field to gauge the strength of the radiation field. As the radiation field increases, the electrical resistivity of the probe decreases. The probe is calibrated using known field strengths and measuring electrical resistivities. Once calibrated, the radiation field strength can be determined by referencing the electrical resistivity of the probe. To eliminate any potential capacitance effects, AC current can be used when taking measurements.

Another embodiment is comprised of number of different detector probes which allow for the differentiation between types of radiation. One detection probe includes a material, such as boron, which experiences measurable RIC changes in a thermal neutron field. another detection probe may be the same material, but coated with a fast or thermal neutron absorber, such as cadmium. The coating removes a large portion of the participating thermal neutrons, leaving the RIC effects on the wire below to be due only to the remaining neutrons. The difference in responses of these wires is used to determine actual flux levels in the radiation field. The control wire is a non-participating material used for calibration as necessary. Other wires may potentially be added to increase resolution, data return, etc. A thermistor that does not experience RIC change can be used to determine operational temperatures.

The elements listed above are connected to regular conductors for measurements, and may include copper, aluminum, or other wires. The resistivity of the materials is measured during irradiation and compared to their normal values.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures are listed below.

FIGS. 1 and 2 show examples of electrical resistivity changing as a function of dose rate involving lithium zirconate and boron nitride.

FIG. 3 shows an exemplary embodiment of responses for thermal and fast spectrum neutrons an uncoated detection wire and a coated detection wire.

FIG. 4 shows an exemplary boron wire changing in resistance as a function of time.

FIG. 5 shows electronic radiation meters with detection wires and signal wires.

FIG. 6 shows a probe with one detector in the shape of a cylindrical puck.

It should be clear that the description of the embodiments and attached figures set forth in this specification serves only for a better understanding, without limiting scope. It should also be clear that a person skilled in the art, after reading the present specification could make adjustments or amendments to the attached figures and above described embodiments that would still be covered by the present disclosure.

### DETAILED DESCRIPTION

The present disclosure is not limited to particular optical systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise.

Unless defined otherwise, all technical and scientific terms used herein have the same meaning as commonly understood by one of ordinary skill in the art.

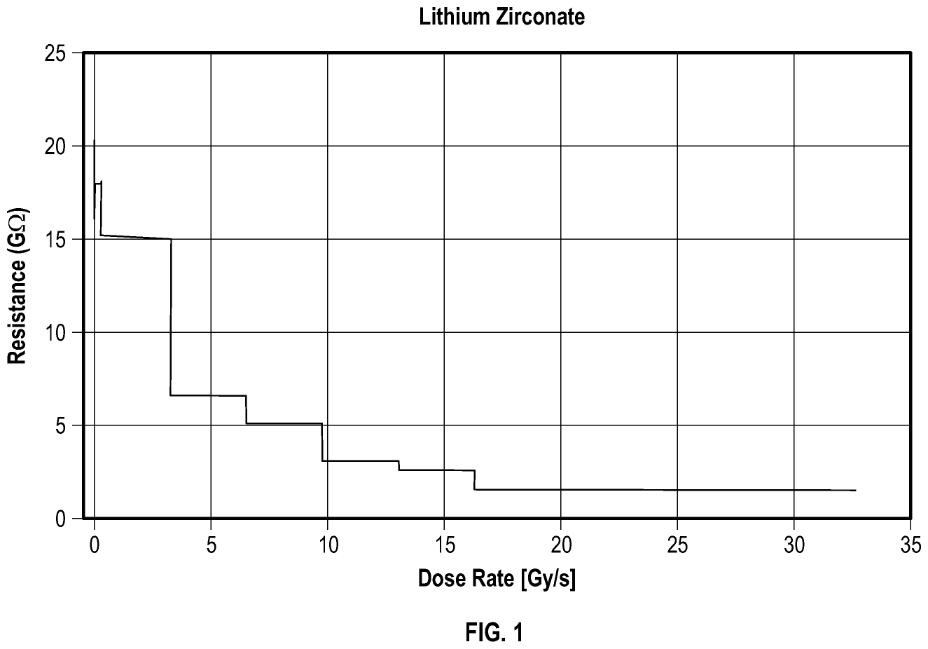

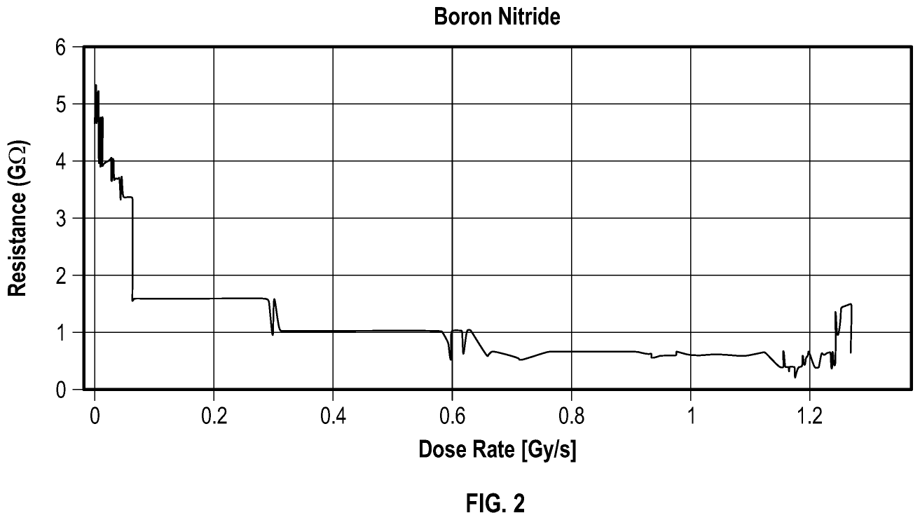

FIGS. 1 and 2 show examples of electrical resistivity changing as a function of dose rate involving lithium zirconate and boron nitride.

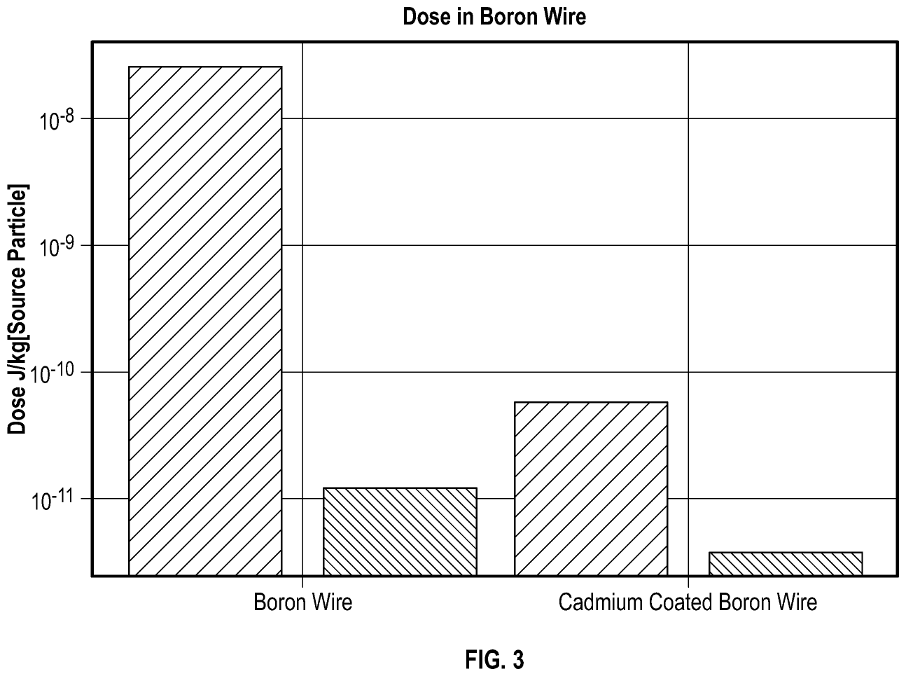

FIG. 3 shows an exemplary embodiment of responses for thermal and fast spectrum neutrons an uncoated detection wire and a coated detection wire. The large difference in the thermal spectrum between the coated and uncoated allows for determination of flux characteristics. The exemplary material for the wire in FIG. 3 is boron and the exemplary coating includes a cadmium coating over a boron wire.

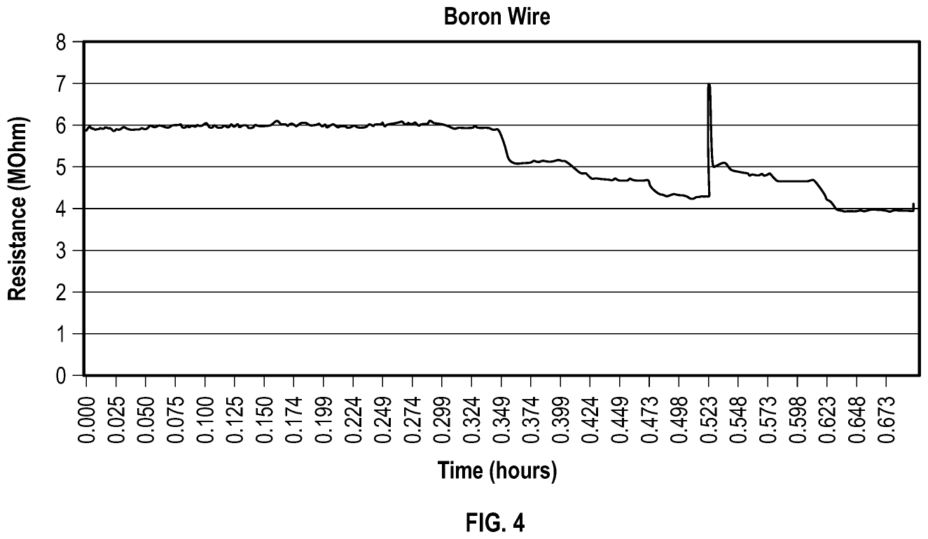

FIG. 4 shows an exemplary boron wire changing in resistance as a function of time. During this time the reactor power was increased in steps, resulting in changes in readings.

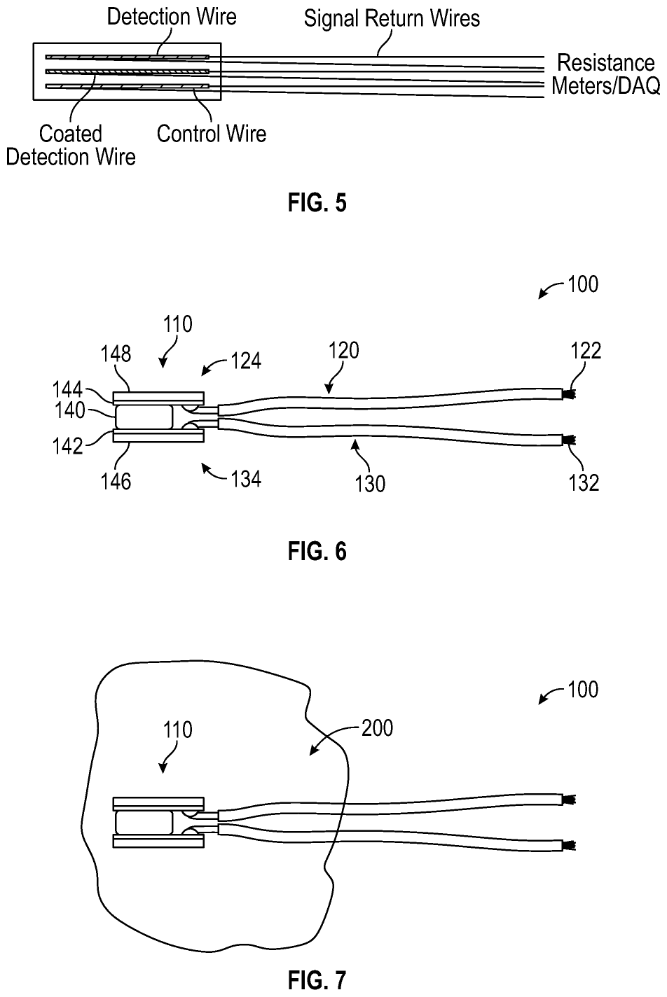

FIG. 5 shows exemplary electronic radiation meters showing detection wires and signal wires. These units may include one or more detectors in the form of wires, kernels, pucks, or other geometry.

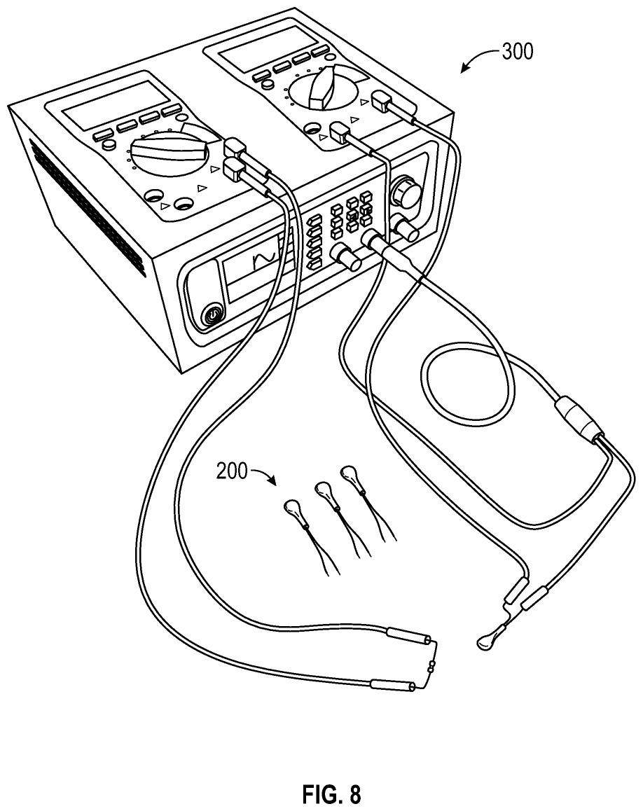

FIG. 6 shows an exemplary probe with one detector in the shape of a cylindrical puck. In the exemplary probe of FIG. 6, a detector 100 with a detector probe 110 is shown. The detector 100 also includes a first wire 120 and a second wire 130. The first wire 120 includes a first end 122 and a second end 124. The second wire 130 includes a first end 132 and a second end 134. Ends 124 and 134 are shown connected two detector probe 110. This connection to detector probe 110 can be by any means, including soldering or otherwise connecting ends 124 and 134 of first wire 120 and second wire 130. As shown in FIG. 6, detector probe 110 includes detector 140 between two metallic discs 142 and 144, which include two external discs 146 and 148. Detector 140, discs 142 and 144, and discs 146 and 148 or secured or otherwise connected together to form detector probe 110.

FIG. 7 shows detector 100 and detector probe 110 can use with detector probe 110 being place within a radiation field 200. The detector 100 through the detector probe 110 measures the electrical resistivity of the radiation field to gauge the strength of the radiation field. As the radiation field 200 increases, the electrical resistivity of the probe 110 decreases. The probe 110 is calibrated using known field strengths and measuring electrical resistivities. Once calibrated, radiation field strength can be determined by referencing the electrical resistivity of the probe 110.

In another embodiment, a number of different detector probes can be utilized to allow for the differentiation between types of radiation. In this example, the first detection probe could include a material, such as boron, which experiences measurable RIC changes in a thermal neutron field. Another detection probe may be of the same material, but coated with a fast or thermal neutron absorber, such as cadmium. The coding removes a large portion of the participating thermal neutrons, leaving the RIC effects on the wire below to be due only to the remaining neutrons. The difference in responses of these wires is used to determine actual flux levels in the radiation field 200. The control wire is a non-participating material used for calibration as necessary. Other wires may potentially be added to increase resolution, data return, etcetera.

Further, while exemplary materials of the elements listed above are provided, the elements listed are connected to regular conductors for measurements generally, and may include copper, aluminum, or other wires. The resistivity of the materials is measured during irradiation and compared to their normal values.

In at least one exemplary embodiment, a detector is provided that includes a first conductive wire and a second conductive wire, and a resistance measuring device connected to a first end of the first conductive wire and to a first end of the second conductive wire. The detector can be formed of a material that experiences Radiation Induced Conductivity (MC) when exposed to radiation. Additionally, the material can be boron, lithium zirconate, boron nitride, alumina, boron carbide, or nickel oxide. Further, the electrical resistivity of the detector can be measured while in radiation field to gauge a strength of the radiation field. Additionally, as the radiation field increases, the electrical resistivity of the detector decreases. Further still, the detector is calibrated using known field strengths and measuring a detector electrical resistivity. Once calibrated, the strength can be determined by referencing the detector electrical resistivity.

In another aspect, a method of operating a detector is provided with the detector comprising a first conductive wire, a second conductive wire, and a resistance measuring device connected to a first end of the first conductive wire and to a first end of the second conductive wire. The method comprises placing the resistance measuring device of the detector in a radiation field to measure electrical resistivity of the detector and the radiation field to gauge a strength of the radiation field. The detector can be formed of a material that experiences Radiation Induced Conductivity (MC) when exposed to radiation. Additionally, the material can be boron, lithium zirconate, boron nitride, alumina, boron carbide, or nickel oxide. Further, the electrical resistivity of the detector can be measured while in radiation field to gauge a strength of the radiation field. Additionally, as the radiation field increases, the electrical resistivity of the detector decreases. Further still, the detector is calibrated using known field strengths and measuring a detector electrical resistivity. Once calibrated, the strength can be determined by referencing the detector electrical resistivity.

In another exemplary embodiment, a combination detector comprising a first detector probe and a second detector can be provided. The first detector probe can include a first wire and a first material that experiences measurable Radiation Induced Conductivity (MC) changes when placed in a thermal neutron field. The second detector probe can include a second wire coated with a coating comprising a fast or thermal neutron absorber. When the combination detector is placed in the thermal neutron field, the coating on the second detector probe removes a portion of thermal neutrons in the thermal neutron field and leaves RIC effects on the second wire below the coating due to a remaining portion of thermal neutrons in the thermal neutron field. Additionally, the first material can be boron. Further, the coating can be cadmium. A difference in responses of the first detector probe and the second detector probe can be used to determine actual flux levels in the thermal neutron field. Further still, a control wire formula of a non-participating material can be used for calibration. Even further, additional wires may be added to the combination detector to increase resolution or data return. The combination detector can be connected to conductors for measurements and may comprise copper, aluminum, or other wires. The resistivity of materials can be measured during irradiation and can be compared to normal resistivity values.

It will be appreciated by those skilled in the art that changes could be made to the embodiments described above without departing from the broad inventive concept thereof. For example, the valve, motor, microcomputer, or flow meter could include additional features. It is understood, therefore, that this disclosure is not limited to the particular embodiments disclosed, but it is intended to cover modifications within the spirit and scope of the present disclosure as defined by the appended claims.

The present disclosure can be understood more readily by reference to the instant detailed description, examples, and claims. It is to be understood that this disclosure is not limited to the specific systems, devices, and/or methods disclosed unless otherwise specified, as such can, of course, vary. It is also to be understood that the terminology used herein is for the purpose of describing particular aspects only and is not intended to be limiting.

The instant description is provided as an enabling teaching of the disclosure in its best, currently known aspect. Those skilled in the relevant art will recognize that many changes can be made to the aspects described, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

As used herein, the singular forms “a,” “an” and “the” include plural referents unless the context clearly dictates otherwise. Thus, for example, reference to a “body” includes aspects having two or more bodies unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

What is claimed is:

1. A detector comprising:
a first conductive wire and a second conductive wire;
a resistance measurement device connected to a first end of the first conductive wire and to a first end of the second conductive wire;
wherein the detector is formed of a material that experiences Radiation Induced Conductivity (RIC) when exposed to radiation.

2. The detector of claim 1 wherein the material is boron, lithium zirconate, boron nitride, alumina, boron carbide, or nickel oxide.

3. The detector of claim 1 wherein electrical resistivity of the detector is measured while in a radiation field to gauge a strength of the radiation field.

4. The detector of claim 3 wherein, as the radiation field increases, the electrical resistivity of the detector decreases.

5. The detector of claim 4 wherein the detector is calibrated using known field strengths and measuring a detector electrical resistivity.

6. The detector of claim 5 wherein, once calibrated, the strength can be determined by referencing the detector electrical resistivity.

7. A method of operating a detector comprising a first conductive wire, a second conductive wire, and a resistance measurement device connected to a first end of the first conductive wire and to a first end of the second conductive wire, the method comprising:
placing the resistance measurement device of the detector in a radiation field to measure electrical resistivity of the detector in the radiation field to gauge a strength of the radiation field;
wherein the detector is formed of a material that experiences Radiation Induced Conductivity (MC) when exposed to radiation.

8. The method of claim 7 wherein the material is boron, lithium zirconate, boron nitride, alumina, boron carbide, or nickel oxide.

9. The method of claim 7 wherein electrical resistivity of the detector is measured while in a radiation field to gauge a strength of the radiation field.

10. The method of claim 9 wherein, as the radiation field increases, the electrical resistivity of the detector decreases.

11. The method of claim 10 further comprising:
calibrating the detector using a known field strength and measuring a detector electrical resistivity.

12. The method of claim 11 wherein, once calibrated, the strength can be determined by referencing the detector electrical resistivity.

13. A combination detector comprising:
a first detector probe and a second detector probe;
the first detector probe including a first wire and a first material that experiences measurable Radiation Induced Conductivity (MC) changes when placed in a thermal neutron field;
the second detector probe including a second wire coated with a coating comprising a fast or thermal neutron absorber;
wherein, when the combination detector is placed in the thermal neutron field, the coating on the second detector probe removes a portion of thermal neutrons in the thermal neutron field and leaves RIC effects on the second wire below the coating due to a remaining portion of thermal neutrons in the thermal neutron field.

14. The combination detector of claim 13 wherein the first material is boron.

15. The combination detector of claim 13 wherein the coating is cadmium.

16. The combination detector of claim 13 wherein a difference in responses of the first detector probe and the second detector probe is used to determine actual flux levels in the thermal neutron field.

17. The combination detector of claim 13 further comprising a control wire comprising a non-participating material used for calibration.

18. The combination detector of claim 17 wherein additional wires may be added to the combination detector to increase resolution or data return.

19. The combination detector of claim 13 wherein the combination detector is connected to conductors for measurements and may comprise copper, aluminum, or other wires.

20. The combination detector of claim 13 wherein resistivity of materials is measured during irradiation and is compared to normal resistivity values.
